(19) United States
(12) Patent Application Publication
(10) Pub. No.: US 2008/0079945 A1
(43) Pub. Date: Apr. 3, 2008

(54) Apparatus and Method to Quantify Laser Head Reference Signal Reliability

(76) Inventors: John P. Flowers, San Jose, CA (US); Alan B. Ray, Palo Alto, CA (US); Eric N. Berseth, Santa Clara, CA (US); Nhan T. Nguyen, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/537,836

(22) Filed: Oct. 2, 2006

(51) Int. Cl. G01B 9/02

(52) U.S. Cl. 356/450

(57) ABSTRACT

A method and apparatus measures signal intensity and frequency of a laser reference signal over time to provide information regarding laser reference signal reliability.

### BACKGROUND

A distance measuring system using laser interferometry is based upon a single or dual frequency reference signal from a laser head. Distance is determined by combining the reference signal with a measurement signal, where the measurement signal is based upon a portion of the reference signal that is reflected from a moving element. The reference signal, therefore, provides a foundation upon which the measurement is based. As the laser head degrades over time, the reference signal eventually reaches a threshold where it is no longer reliable and the laser head must be replaced.

Conventional laser interferometers do not indicate when a reference signal has degraded to the point of requiring replacement of the laser head. Accordingly, determination of laser head reference signal degradation typically requires connection of an external measurement device to the laser head test port or disassembly of the laser interferometer system to make a laser head power measurement. Laser interferometers are typically expensive devices that are part of production lines with expensive down time costs. Accordingly, instead of measuring the reference signal, a typical solution that accommodates laser head degradation is a planned obsolescence and replacement of the laser head after some period of time. Disadvantageously, the lifespan of a laser head is not consistent from device to device to make the planned obsolescence financially efficient because a planned obsolescence over a fixed amount of time may call for laser head replacement well before actual reference signal degradation or well after the reference signal has already significantly degraded.

There are situations where a location or set-up of a laser interferometer can cause degradation of a reference signal when the laser head would work properly if located or situated differently. In this situation, disassembly and direct measurement of the reference signal results in a measurement indicating that a problem does not exist. Conventional laser interferometers do not provide specific measurements that provide a qualitative measurement of the reference signal in situ.

There is a need, therefore, for an improved method and apparatus to determine laser head reference signal health.

### BRIEF DESCRIPTION OF THE DRAWINGS

An understanding of the present teachings can be gained from the following detailed description, taken in conjunction with the accompanying drawings of which like reference numerals in different drawings refer to the same or similar elements.

FIG. 1 is a block diagram of a conventional laser interferometer system.

FIG. 2 is a block diagram of a signal processing element according to the present teachings.

FIG. 3 is a flow chart of an embodiment of a method according to the present teachings to quantify laser head reference signal reliability.

FIG. 4 is a flow chart illustrating steps to measure reference signal health according to the present teachings.

### DETAILED DESCRIPTION

In the following detailed description, for purposes of explanation and not limitation, example embodiments disclosing specific details are set forth in order to provide an understanding of embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

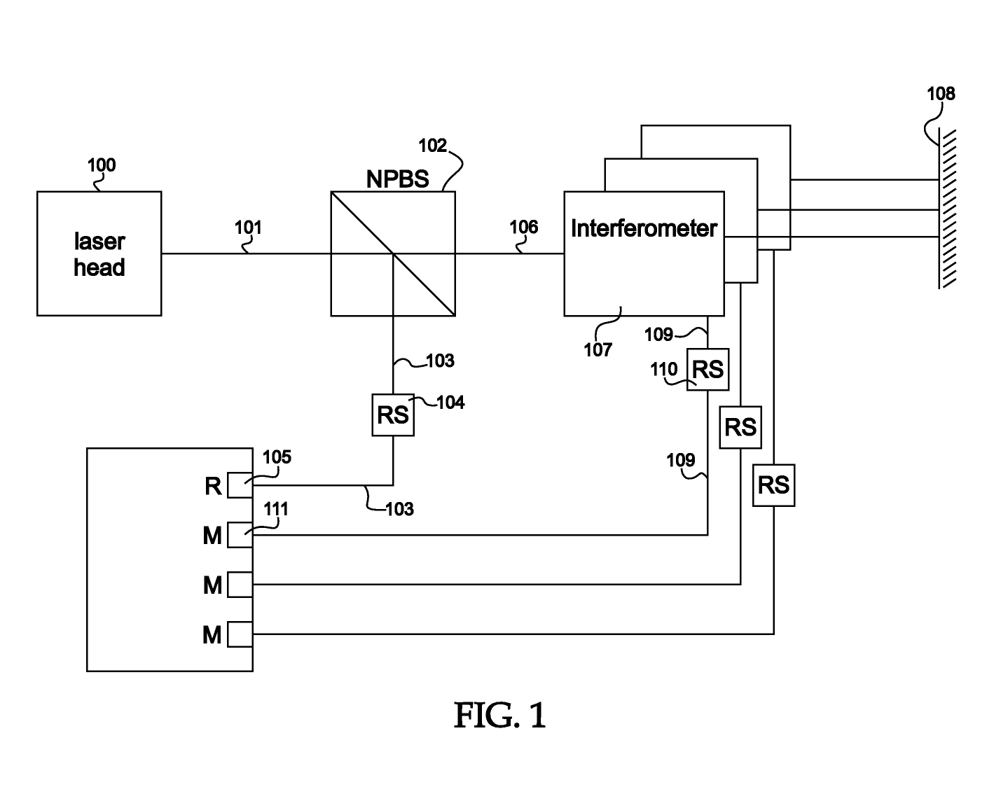

With specific reference to FIG. 1 of the drawings, there is shown a conventional laser interferometry system including a laser head 100. In a specific embodiment of a heterodyne laser interferometry system according to the present teachings, the laser head 100 generates a laser signal 101 comprising two light frequencies at a constant split frequency. The laser signal 101 is directed to a nonpolarizing beam splitter 102 that splits off a reference signal portion 103 of the laser signal 100. The reference signal portion 103 is directed to a remote sensor 104 that accepts the reference signal portion and launches it into an optical fiber. The optical fiber brings the reference signal portion into a reference signal processor 105. A portion of the light signal 101 that passes through the beam splitter 102 is a measurement signal portion 106. The measurement signal portion 106 is used in conjunction with one or more interferometer assemblies 107 to illuminate a target 108. A reflection of the measurement signal portion 109 is directed to a respective measurement remote sensor 110 and into a measurement signal processor 111. Each additional axis of displacement measurement uses an additional measurement signal portion, interferometer assembly, remote sensor, and measurement processor.

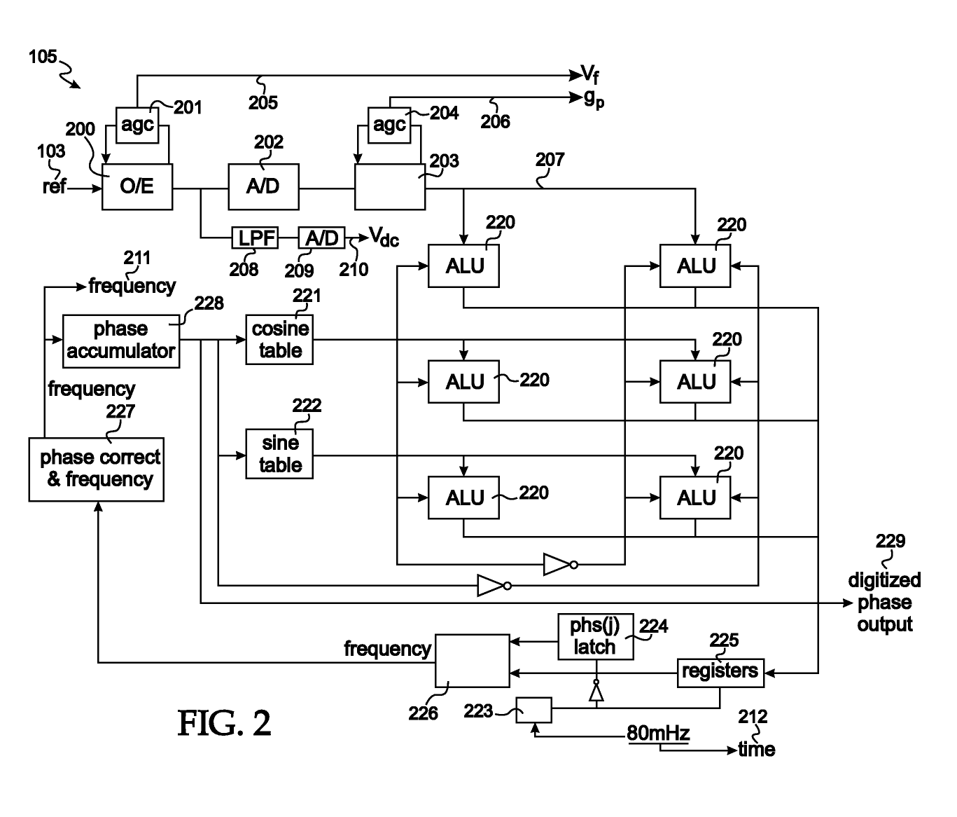

With specific reference to FIG. 2, there is shown a simplified block diagram of an embodiment of the reference signal processor 105 according to the present teachings. The reference signal portion 103 is directed to an avalanche photo diode (herein “APD”) that operates as an optical to electrical converter 200 (herein “O/E”). The APD 200 includes an O/E automatic gain control (“O/E AGC”) 201 as a first stage of gain control. The O/E AGC 201 ensures that a digital input 207 into the reference signal processor 105 is within an optimum range for purposes of the reference signal process function. An output of the O/E AGC 201 is a feedback control voltage (herein “V_{f}”) 205. The output of the APD 200 is directed to first and second digitizing elements 202 and 208, 209. The first digitizing element 202 accepts an analog input from the O/E 200 and digitizes it. The second digitizing element 208, 209 comprises low pass filter 208 in series with second A/D 209. As one of ordinary skill in the art appreciates, the digitized output of the first digitizing element 202 has contains high frequency information not contained in the digitized output of the second digitizing element 209. In a specific embodiment, the low pass filter 208 comprises a resistive/capacitive combination with a 30.1 kohm resistor and 470 pFarad capacitor. The cut-off frequency of the low pass filter 208 is 11.2 kHz so as to filter out the 100 kHz Doppler minimum frequency of the interferometer system, while still passing through the 100 Hz low frequency bandwidth.

The output 211 of the first digitizing element 202 is the input to offset conditioner and prescaler 203. The offset conditioner corrects for any remaining DC offset and the prescaler adjusts the magnitude of the input signal to be within a fixed range that is most efficient for further phase processing. The output of the second digitizing element 209 is the DC offset voltage (herein “V_{dc}”) 210. The digital value output of the first A/D 202 is connected to offset conditioner and prescaler 203. The offset conditioner and prescaler 203 has a digital input conditioner AGC 204. The digital input conditioner AGC 204 sizes the digital output 207 to be at a predetermined value that is known to be most efficient for the function of the signal processor 105. An output of the digital input conditioner AGC 204 is a phase processor gain (herein “gₚ”) 206.

The digital output 207 of the offset conditioner and prescaler 203 is directed into a series of arithmetic logic units (herein “ALUs” 220), sine and cosine look up tables 221, 222, counter 223, phase latch 224, storage registers 225, FPGA 226 that calculates and updates the current frequency, phase correction and frequency update state machine 227 that produces a corrected phase 229 and updated frequency 211 values, and phase accumulator 228, all of which operate together as shown in FIG. 2 of the drawings and in accordance with the teachings of commonly assigned U.S. Pat. No. 6,480,126 the contents of which are hereby incorporated by reference. The reference signal processor 105 generates continuously updated digital phase information based upon the incoming optical signal 103. As part of the function of the digital phase calculations of the reference signal processor 105, the split frequency 211 of the reference signal input 103 is calculated. In a specific embodiment, the signal processor 105 operates using an 80 MHz processor clock 212. The processor clock 212 is used to calculate a time base against which the measured data may be represented. Other embodiments of a reference signal processor that measure signal intensity and frequency are also consistent with the present teachings, this particular embodiment chosen for illustration because it measures AC and DC signal intensity and frequency as part of the continuous phase processing function. Accordingly, the specific measurements do not degrade the efficiency of the phase processing function and may be employed for the additional useful purpose of assessing reference signal reliability.

It is suggested that laser head reliability may be monitored and assessed based upon laser AC and DC signal intensity over time and laser frequency over time. For purposes of laser signal reliability, AC signal intensity may be calculated as:

$${P}_{a c} = {K}_{attn} \frac{{M}_{a c}}{{g}_{p}} \qquad ( 1 )$$

Kₐ, K_{b}, and K_{c} are calibration constants for the APD 200. Calibration of the APD 200 comprises ramping the signal intensity of a calibration signal and measuring the output of the AGC 205. The resulting data is fit to a quadratic equation where the calibration constants Kₐ, K_{b}, and K_{c} are the quadratic, linear and constant coefficients, respectively. Kₐₜₜₙ is then calculated as a function of V_{f} where:

Kₐₜₜₙ=KₐV_{f}²+K_{b}V_{f}+K_{c} (2)

M_{ac} is also a calibration constant. As part of the calibration process that ramps the signal intensity of a calibration signal, the phase processor gain 206 is also measured. The resulting phase processor gain is fit to a linear equation and M_{ac} is the slope of the resulting fit. Therefore, AC signal intensity is calculated as a function of V_{f} and gₚ.

Also for purposes of laser signal reliability, a DC signal intensity may be calculated as:

P_{dc}=Kₐₜₜₙ(M_{dc}V_{dc}+B_{dc}) (3)

M_{dc} and B_{dc} are also calibration constants. M_{dc} and B_{dc} are calculated based upon a calibration that measures V_{dc} as the input calibration signal 103 ramps in intensity. The measured V_{dc} is fit to a linear curve and M_{dc} and B_{dc} is the slope and y-intercept of the linear fit of the collected calibration data, respectively.

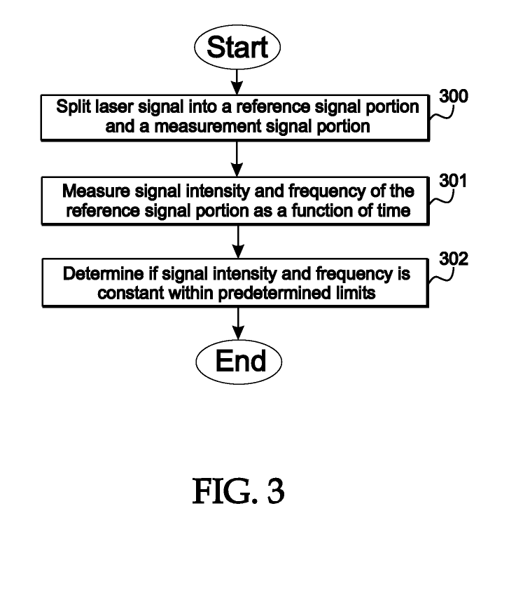

With specific reference to FIG. 3 of the drawings, there is shown a flow chart of a specific embodiment of a process for determining signal intensity as a function of the feedback control voltage (“V_{f}”) and the phase processor gain (“gₚ”). As a preliminary process not shown in the flow chart, a calibration process linearly ramps a reference signal intensity and calculates the calibration constants as previously described. Based upon the calculated calibration constants, a look-up table is created for various combinations of values of V_{f} and gₚ and the resulting P_{ac} as well as for various values of P_{dc} as a function of V_{dc}.

During operation and with specific reference to FIG. 3, a laser signal is split 300 into a reference signal portion 103 and a measurement signal portion. The AC and DC signal intensity and the frequency of the reference signal portion 103 is measured 301 at periodic intervals. Based upon the measurement of signal intensity and frequency, laser signal reliability may be assessed by determining 302 if the signal intensity and frequency is within predetermined limits over a period of time.

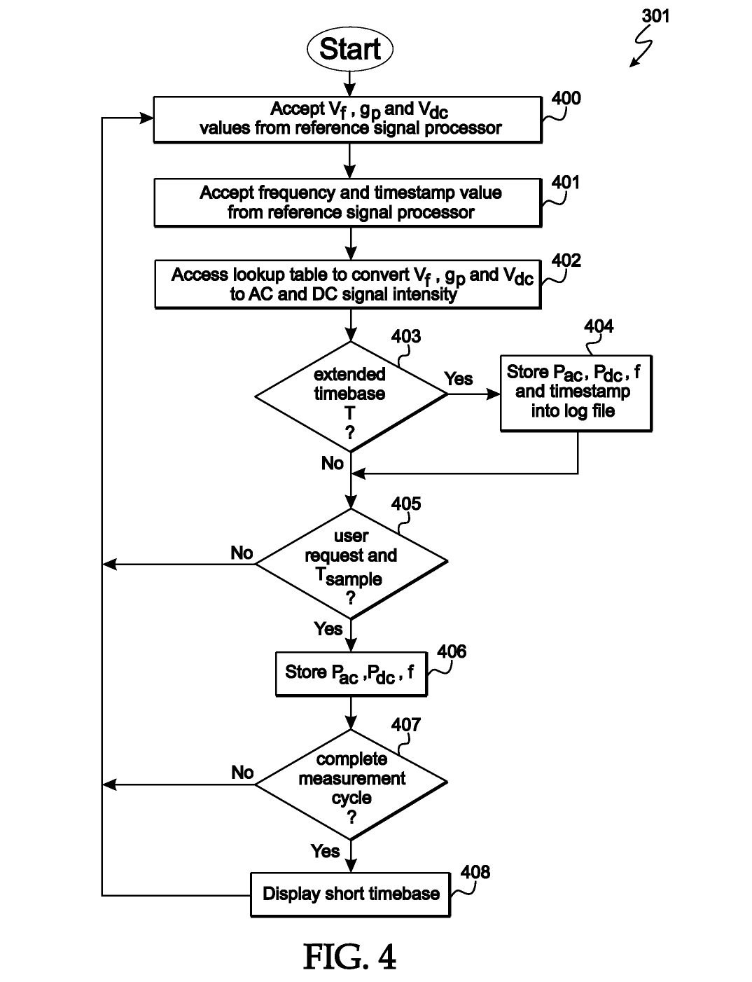

In a specific embodiment of the measurement step 301 of the process and with specific reference to FIG. 4 of the drawings, an analysis processor accepts 400 values for V_{f}, gₚ, and V_{dc} from the reference signal processor 105 and based upon the received values, accesses 402 pre-calculated look up tables to determine values for P_{ac} and P_{dc}. The analysis process also accepts 401 a value for frequency and a timestamp based upon the time base 212. The signal intensity data, P_{ac} and P_{dc}, and the reference signal frequency 211 is gathered on a periodic basis together with a timestamp. The gathered data are part of a laser reliability investigation wherein the same data may be used for two different reliability assessments. In a first embodiment of a measurement according to the present teachings, the data is gathered 406 at a relatively short sample period, i.e. every 3.2 usec, upon specific initiation 405 of the measurement by a user and the data are stored locally 406 and then displayed 408. In a second embodiment of a measurement according to the present teachings, the data is gathered automatically at a relatively extended predetermined periodic interval 403, i.e. every month, and stored 404 in a log file in non-volatile memory. The data stored in the log file may be always displayed to the user or may be retrieved from the log file in a separate process and displayed to the user upon request.

The first laser reliability assessment uses a short time base and quantifies any instantaneous reference signal instability. Ideally, both the signal intensity and the frequency are constant over the short time base. If the reference signal is unstable, the short time base measurements of frequency and signal intensity show some amount of modulation. Instantaneous reference signal instability reflects modulation that is commonly on the order of approximately 10's of kilohertz. Accordingly, it is acceptable to measure and graph the data over a bandwidth of 100's of kilohertz. In a specific embodiment, the time base is 80 MHz and the AC and DC signal intensity and frequency data is acquired every 3.2 usec. If the laser signal is reliable, the signal intensity and frequency as functions of time are substantially constant and unmodulated. If there is instantaneous reference signal instability, the graph of signal intensity and frequency as a function of time exhibits some amount of modulation. To show modulation, the gathered data may be graphed as a function of time or can be shown in numeric form as an average and peak to peak values over a measurement cycle. If the amplitude of the frequency or signal intensity modulation exceeds a predetermined threshold, it is an indication that the reference signal is unstable or “freebling”. If the reference signal is unstable, there are a number of possible causes including, but not limited to placement of the laser source near ferrous materials, external cavity feedback and optical path feedback. The number of possible causes provides a number of possible fixes. It is ultimately up to the user to find the right fix, but the measurement and display according to the present teachings permits the user to partially diagnose a system problem by identifying that there is an issue with the reference signal.

A second laser reliability measurement uses an extended time base and indicates if the laser source is reaching an end of its useful life. Signal intensity and frequency, therefore, may be measured at a specific time every day, week, month, or other unit of periodicity. Because a date and timestamp is also collected, it is acceptable that the data not be collected at a constant periodicity, as long as the data can be correlated in time. A typical laser head product life in an interferometer system is on the order of 3-5 years. Accordingly, the periodicity of the measurement may be selected to measure a significant sample of data points over the expected life of the laser. In a specific embodiment, the signal intensity and frequency data is gathered every month and is stored or maintained in a log file in non-volatile memory with a time and date stamp. The signal intensity and frequency measurements are substantially constant during the useful life of the laser head. As the laser head reaches the end of its useful life, the signal intensity or frequency measurement begins to show a trend of degradation. Every so often, therefore, and upon request of the user, the extended time base data may be displayed 303. The extended time base measurement is most helpful as a relative measurement. The measurements may be compared to a baseline reading taken at the beginning of the laser head product life or compared to a specification. The extended time base display may be in the form of a graph of frequency and signal intensity versus time that includes the baseline reading or may be a display of a numeric showing average and peak to peak values of the baseline reading as compared to the current reading. Alternatively, the baseline reading is not displayed and a user compares the current reading to a value in the product specifications. An advantage of graphical representation of the data is that gradual degradation can be represented that provides a visual indication of a degradation trend and a qualitative rate of the degradation trend. An advantage of the numerical representation is that it can be represented without using much of the graphical user interface display space. The instantaneous and trend data may be shown upon demand or may be shown all the time in a corner of the standard display screen.

Embodiments of the teachings are described herein by way of example with reference to the accompanying drawings describing an apparatus and method for quantifying reference signal reliability in a laser system. The specific embodiment described is a heterodyne laser interferometer system. One of ordinary skill in the art with benefit of the present teachings, however, recognizes that the same principle of measuring the reference signal over time to assess reference signal reliability is also applicable to homodyne laser systems. Other variations, adaptations, and embodiments of the present teachings will occur to those of ordinary skill in the art given benefit of the present teachings.

1. An apparatus comprising:
A laser emitting a light signal,
A redirection element directing a reference signal portion of the light signal into a reference signal processor, wherein the reference signal processor measures the reference signal portion as a function of time to provide information regarding laser reliability.

2. An apparatus as recited in claim 1 wherein the redirection element is a beam splitter.

3. An apparatus as recited in claim 1 wherein the light signal comprises two different frequencies of light and a split frequency of the light signal is measured as a function of time.

4. An apparatus as recited in claim 3 wherein the function of time is in a resolution on the order of no more than 10 msec.

5. An apparatus as recited in claim 3 wherein the function of time is in a resolution on the order of at least a day.

6. An apparatus as recited in claim 1 wherein a signal intensity of the light signal is measured as a function of time.

7. An apparatus as recited in claim 6 wherein a resolution of the time function is no more than a 10 msec.

8. An apparatus as recited in claim 6 wherein a resolution of the time function is no less than a day.

9. An apparatus as recited in claim 8 wherein each data point is stored in a log file with a time date stamp for later retrieval.

10. An apparatus as recited in claim 1 and further comprising a display wherein the measured reference signal portion is displayed as a function of time.

11. An apparatus as recited in claim 1 and further comprising a visual indication of when the reference signal portion is outside of predetermined limits.

12. A method for measuring laser health comprising
Splitting a laser signal into a reference signal portion and a measurement signal portion,
Measuring a signal intensity of the reference signal portion as a function of time, and
Determining if the signal intensity is constant within predetermined limits.

13. A method as recited in claim 12 wherein measuring comprises routing the reference signal portion into a reference signal processor, accepting feedback control voltage and phase processor gain data from the reference signal processor, and converting the feedback control voltage and phase processor gain data into the signal intensity.

14. A method as recited in claim 13 wherein converting comprises accessing a look up table to acquire the signal intensity.

15. A method as recited in claim 12 and displaying the signal intensity as a function of time.

16. A method as recited in claim 15 wherein time is measured with no more than 10 msec resolution.

17. A method as recited in claim 15 wherein time is measured with no less than day resolution.

18. A method as recited in claim 12 wherein the laser signal comprises two light frequencies and measuring a split frequency of the reference signal portion as a function of time and determining if the split frequency is constant within predetermined limits.

19. A method as recited in claim 18 wherein the split frequency is measured as a function of time.

20. A method for measuring laser health comprising
Splitting a laser signal into a reference signal portion and a measurement signal portion,
Measuring a frequency of the reference signal portion as a function of time, and
Determining if the frequency is constant within predetermined limits.

21. A method as recited in claim 20 and further comprising displaying the frequency as a function of time.

22. A method as recited in claim 20 wherein the laser signal comprises two different frequencies and the frequency of the reference signal portion comprises the split frequency.

23. A method as recited in claim 20 wherein the laser signal comprises a signal frequency and the frequency of the reference signal portion comprises the absolute frequency.

24. A method as recited in claim 20 wherein a resolution of time is no more than 10 msec.

25. A method as recited in claim 20 wherein a resolution of time is no less than a day.
